(19) United States
(12) Patent Application Publication
(10) Pub. No.: US 2024/0394666 A1
(43) Pub. Date: Nov. 28, 2024

(54) INFORMATION PROCESSING DEVICE AND INFORMATION PROCESSING METHOD

(71) Applicant: TOYOTA JIDOSHA KABUSHIKI KAISHA, Toyota-shi (JP)

(72) Inventor: Tetsuro ISHII, Nagoya-shi (JP)

(73) Assignee: TOYOTA JIDOSHA KABUSHIKI KAISHA, Toyota-shi (JP)

(21) Appl. No.: 18/441,160

(22) Filed: Feb. 14, 2024

(30) Foreign Application Priority Data
May 23, 2023 (JP) 2023-084636

(51) Int. Cl. G06Q 10/20

(52) U.S. Cl. CPC G06Q 10/20

(57) ABSTRACT

The control unit of the information processing device acquires the travel start date and time when the vehicle is scheduled to start moving, and the scheduled route of the vehicle. In addition, if the travel distance or travel time of the vehicle on the scheduled route is equal to or greater than the threshold, the control unit of the information processing device determines the items that the vehicle user should check in the vehicle by the travel start date and time. Decide on a checklist. Then, the control unit of the information processing device transmits checklist information including the checklist to a terminal associated with the user.

### CROSS-REFERENCE TO RELATED APPLICATION

This application claims priority to Japanese Patent Application No. 2023-084636 filed on May 23, 2023, incorporated herein by reference in its entirety.

### BACKGROUND

### 1. Technical Field

The present disclosure relates to an information processing device and an information processing method.

### 2. Description of Related Art

Japanese Unexamined Patent Application Publication No. 2021-5151 (JP 2021-5151 A) discloses an information providing program to be executed by a computer. The information providing program disclosed in JP 2021-5151 A allows the computer to acquire image information correlated with user information and schedule information correlated with the user information. The computer uses the information providing program to determine insurance information to be proposed to the user based on the image information and the schedule information, and also to determine the timing to propose the insurance information based on the schedule information. Then, the computer uses the information providing program to provide the insurance information to the information processing terminal correlated with the user information at the determined timing to provide the insurance information.

### SUMMARY

The present disclosure has an object to suppress a trouble occurring in a vehicle during travel.

A first aspect of the present disclosure provides an information processing device including a control unit configured to:
acquire a travel start date and time when a vehicle is scheduled to start traveling and an expected route of the vehicle;
determine a checklist of items to be checked for the vehicle by a user of the vehicle by the travel start date and time when a travel distance or a travel time for travel of the vehicle on the expected route is greater than or equal to a threshold value; and
transmit checklist information including the checklist to a terminal associated with the user.

A second aspect of the present disclosure provides an information processing method to be executed by a computer, the information processing method including:
acquiring a travel start date and time when a vehicle is scheduled to start traveling and an expected route of the vehicle;
determining a checklist of items to be checked for the vehicle by a user of the vehicle by the travel start date and time when a travel distance or a travel time for travel of the vehicle on the expected route is greater than or equal to a threshold value; and
transmitting checklist information including the checklist to a terminal associated with the user.

According to the present disclosure, it is possible to suppress a trouble occurring in a vehicle during travel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a notification system;

FIG. 2 is a block diagram schematically showing an example of the functional configuration of the management server;

FIG. 3 is a diagram showing an example of a table structure of schedule information held in a schedule information database;

FIG. 4 is a diagram showing an example of a table structure of vehicle information held in a vehicle information database;

FIG. 5 is a diagram showing an example of a table structure of correspondence information held in the correspondence information database; and

FIG. 6 is a flowchart of information processing executed by the control unit of the management server.

### DETAILED DESCRIPTION OF EMBODIMENTS

When a vehicle travels a long distance or for a long time, it is assumed that the possibility of trouble occurring in the moving vehicle is higher than when the vehicle travels a short distance or for a short time. On the other hand, by having the user check the vehicle before the vehicle travels over a long distance or for a long time, it is possible to suppress the possibility that trouble will occur in the vehicle while it is moving.

Therefore, the control unit of the information processing device according to the first aspect of the present disclosure acquires the travel start date and time when the vehicle is scheduled to start moving, and the scheduled route that the vehicle is scheduled to travel. Here, the scheduled route is the route on which the vehicle starts moving and is scheduled to travel at the travel start date and time. The control unit of the information processing device according to the first aspect of the present disclosure is configured such that if the travel distance or travel time when the vehicle travels on the scheduled route is greater than or equal to a threshold value, the user of the vehicle may drive the vehicle by the travel start date and time. Determine a checklist of items to be checked. The control unit then transmits checklist information including the checklist to a terminal associated with the user.

As described above, when the user moves for a distance or time greater than a threshold value, the information processing device transmits checklist information to a terminal associated with the user. This prompts the user to check the vehicle according to the checklist before the travel start date and time arrives. As a result, maintenance of the vehicle can be performed, and troubles occurring in the moving vehicle can be suppressed.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### Embodiment

### System Overview

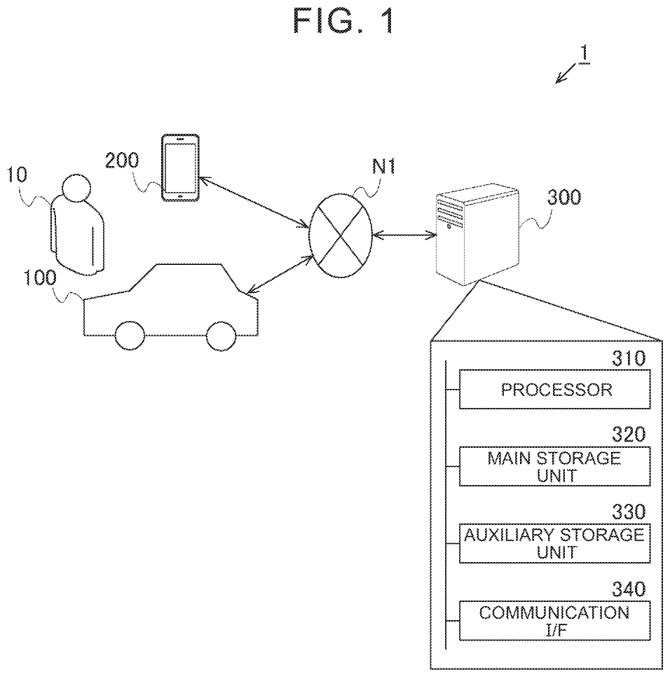

A notification system 1 in this embodiment will be explained based on FIG. 1. FIG. 1 is a diagram showing a schematic configuration of a notification system 1. The notification system 1 includes a vehicle 100, a user terminal 200, and a management server 300. In the notification system 1, a vehicle 100, a user terminal 200, and a management server 300 are interconnected by a network N1. The network NI may be, for example, a Wide Area Network (WAN), which is a world-wide public communication network such as the Internet, or a telephone communication network such as a mobile phone.

### Vehicle

Vehicle 100 is a vehicle used by user 10. When the user 10 travels a long distance using the vehicle 100, it is assumed that the possibility of trouble occurring in the moving vehicle 100 is higher than when the user 10 travels a short distance using the vehicle 100. On the other hand, if the user 10 checks the vehicle 100 before traveling a long distance in the vehicle 100, the possibility of trouble occurring in the moving vehicle 100 is suppressed.

Additionally, the vehicle 100 acquires vehicle information indicating the state of the vehicle 100 from an electronic control unit or the like, and transmits it to the management server 300 via the network N1. Here, the vehicle information includes, for example, the state of consumables such as the state (amount) of oil in the vehicle 100, the state of the battery (degree of deterioration), the state (amount) of coolant, or the state of tires (amount worn out). Contains information indicating. The state of vehicle 100 is acquired by a sensor mounted on vehicle 100. A sensor mounted on vehicle 100 acquires the state of vehicle 100 in real time. Vehicle 100 then transmits vehicle information to management server 300 in real time via network N1.

### User Terminal

User terminal 200 is a terminal related to user 10. The user terminal 200 is, for example, a mobile information terminal or a computer used by the user 10. The user 10 inputs a travel schedule of the user 10 using the vehicle 100 into the user terminal 200. Vehicle 100 transmits schedule information including a schedule for movement of user 10 by vehicle 100 to management server 300 via network N1. Here, the schedule information includes information indicating the travel start date and time when the user 10 is scheduled to start traveling by the vehicle 100. Further, the schedule information includes information indicating the point and destination where the user 10 plans to start traveling by the vehicle 100.

Further, the user terminal 200 receives checklist information from the management server 300 via the network N1. Here, the checklist information is information including a checklist of items that the user 10 should check in the vehicle 100 by the travel start date and time. Here, the items that the user 10 should check on the vehicle 100 by the travel start date and time include, for example, visually checking the parts on the user 10. Further, the items that the user 10 should check in the vehicle 100 before the travel start date and time include, for example, replacing parts or consumables in the user 10.

### Management Server

The management server 300 is a server that manages the movement schedule of the user 10. Management server 300 receives schedule information from user terminal 200 via network N1. The management server 300 refers to the schedule information and generates checklist information. Management server 300 then transmits the checklist information to vehicle 100 via network N1. Details of how management server 300 transmits checklist information to vehicle 100 will be described later.

The management server 300 includes a computer having a processor 310, a main storage unit 320, an auxiliary storage unit 330, and a communication interface (communication I/F) 340. Processor 310 is, for example, a Central Processing Unit (CPU) or a Digital Signal Processor (DSP). The main storage unit 320 is, for example, Random Access Memory (RAM). The auxiliary storage unit 330 is, for example, a Read Only Memory (ROM). Further, the auxiliary storage unit 330 is, for example, a Hard Disk Drive (HDD), or a disc recording medium such as a CD-ROM, a DVD disc, or a Blu-ray disc. Further, the auxiliary storage unit 330 may be a removable medium (portable storage medium). Examples of the removable medium include a USB memory or an SD card. The communication I/F 340 is, for example, a Local Area Network (LAN) interface board or a wireless communication circuit for wireless communication.

In the management server 300, the auxiliary storage unit 330 stores an operating system (OS), various programs, various information tables, and the like. In the management server 300, the processor 310 loads a program stored in the auxiliary storage unit 330 in the main storage unit 320 and executes the program, thereby being able to implement various functions described below. However, some or all of the functions of the management server 300 may be realized by a hardware circuit such as an ASIC or an FPGA. The management server 300 is not necessarily implemented by a single physical configuration, and may be constituted by a plurality of computers that cooperates with one another.

### Functional Configuration

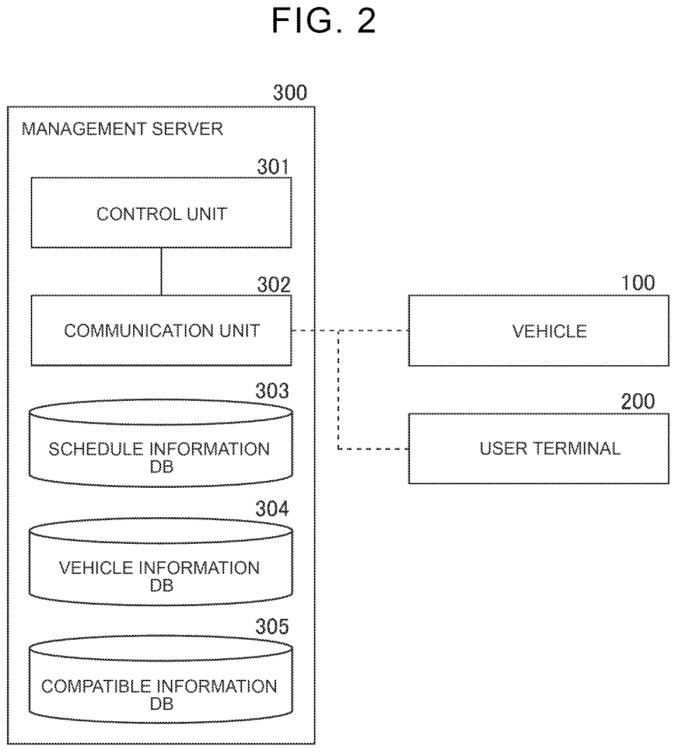

Next, the functional configuration of the management server 300 that constitutes the notification system 1 will be described based on FIGS. 2 to 5. FIG. 2 is a block diagram schematically showing an example of the functional configuration of the management server 300.

The management server 300 includes a control unit 301, a communication unit 302, a schedule information database 303 (schedule information DB 303), a vehicle information database 304 (vehicle information DB 304), and a correspondence information database 305 (correspondence information DB 305). The control unit 301 has a function of executing an arithmetic process required for controlling the management server 300. The control unit 301 can be implemented by the processor 310 in the management server 300. The communication unit 302 has a function of connecting the management server 300 to the network N1. The communication unit 302 can be realized by the communication I/F 340 in the management server 300.

The control unit 301 receives schedule information regarding the user 10 from the user terminal 200 through the communication unit 302. The control unit 301 stores schedule information received from the user terminal 200 in the schedule information DB 303. The schedule information DB 303 has a function of holding schedule information. The schedule information DB 303 can be realized by the auxiliary storage unit 330 in the management server 300.

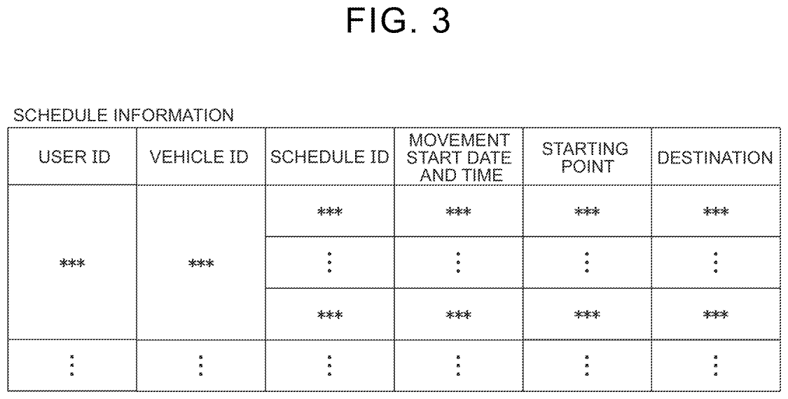

FIG. 3 is a diagram showing an example of a table structure of schedule information held in the schedule information DB 303. As shown in FIG. 3, the schedule information includes a user ID field, a vehicle ID field, a schedule ID field, a movement start date and time field, a movement start point field, and a destination field.

The user ID field stores an identifier (user ID) for identifying the user. The vehicle ID field stores an identifier (vehicle ID) for identifying the user's vehicle. Here, the schedule information held in the schedule information DB 303 stores the user ID of the user 10 and the vehicle ID of the vehicle 100. The schedule ID field stores an identifier (schedule ID) for identifying the schedule on which the user travels by vehicle.

The movement start date and time field stores information indicating the user's movement start date and time. The movement start point field stores information indicating the point where the user plans to start moving by vehicle (movement start point). The destination field stores information indicating the destination to which the user moves from the movement start point. Information indicating the latitude and longitude of the movement start point and destination are stored in the movement start point field and the destination field, respectively.

The control unit 301 can grasp the date and time when the user 10 starts moving by the vehicle 100 by acquiring schedule information about the user 10 from the schedule information DB 303. Further, the control unit 301 can grasp the distance that the vehicle 100 is scheduled to travel (hereinafter sometimes referred to as “traveling distance”) by acquiring schedule information about the user 10 from the schedule information DB 303. Specifically, the control unit 301 acquires information indicating the movement start point stored in the movement start point field and information indicating the destination stored in the destination field. Then, the control unit 301 searches for a planned route from the movement start point to the destination. Then, the control unit 301 calculates the distance traveled by the vehicle 100 along the planned route as the travel distance.

The control unit 301 refers to the schedule information held in the schedule information DB 303 and determines whether there is a schedule in which the travel distance of the vehicle 100 is a predetermined distance or more (hereinafter sometimes referred to as a “specific schedule”). Determine whether. Thereby, the control unit 301 can grasp whether the user 10 has a specific schedule.

Furthermore, the control unit 301 receives vehicle information regarding the vehicle 100 from the vehicle 100 through the communication unit 302. The control unit 301 stores vehicle information received from the vehicle 100 in the vehicle information DB 304. The vehicle information DB 304 has a function of holding vehicle information. The vehicle information DB 304 can be realized by auxiliary storage unit 330 in management server 300.

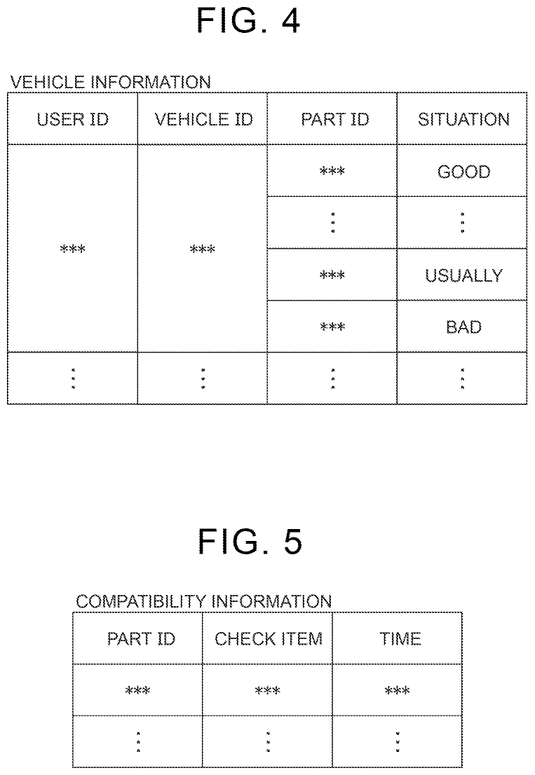

FIG. 4 is a diagram showing an example of a table configuration of vehicle information held in the vehicle information DB 304. As shown in FIG. 4, the vehicle information includes a user ID field, a vehicle ID field, a part ID field, and a status field.

The user ID field stores an identifier (user ID) for identifying the user. The vehicle ID field stores an identifier (vehicle ID) for identifying the user's vehicle. Here, the user ID of the user 10 and the vehicle ID of the vehicle 100 are stored in the vehicle information held in the vehicle information DB 304.

The part ID field stores an identifier (part ID) for identifying each part in the vehicle. The part ID field stores, for example, a part ID for an oil filter, a part ID for a battery, a part ID for a reservoir tank that supplies coolant, a part ID for each tire of a vehicle, and the like. The status field stores information indicating the status of the part (including the status of consumables related to the part) corresponding to the part ID stored in the part ID field. The status field stores, for example, information such as “good”, “normal”, or “bad” as information indicating the status of the part corresponding to the part ID stored in the part ID field. Here, information other than “good”, “fair”, and “bad” may be stored in the status field. For example, a detection value detected by a sensor mounted on the vehicle may be directly stored in the status field. The control unit 301 can grasp the state of the vehicle 100 by acquiring vehicle information about the vehicle 100 from the vehicle information DB 304.

Here, information indicating the state of the part corresponding to the part ID stored in the part ID field is determined by a detection value detected by a sensor mounted on the vehicle. Here, three ranges are defined for each detected value so that it belongs to either “good”, “normal”, or “bad”. Then, based on which range the detection value detected by the sensor mounted on the vehicle belongs, information indicating the status as “good”, “normal”, or “bad” is stored in the part ID field. be done.

When the control unit 301 determines that a specific schedule exists by referring to the schedule information held in the schedule information DB 303, the control unit 301 acquires vehicle information about the vehicle 100 from the vehicle information DB 304. Then, the control unit 301 refers to the vehicle information and the correspondence information held in the correspondence information DB 305, and determines a checklist of items that the user 10 should check in the vehicle 100 by the travel start date and time. The correspondence information is information for associating parts in poor condition with check items for the parts.

FIG. 5 is a diagram showing an example of a table configuration of correspondence information held in the correspondence information DB 305. The correspondence information DB 305 can be realized by the auxiliary storage unit 330 in the management server 300. As shown in FIG. 5, the correspondence information includes a part ID field, a check item field, and a time field.

The part ID field stores part IDs of parts mounted on the vehicle. The check item field stores information indicating items (check items) that the user 10 should check when the condition of the part corresponding to the part ID stored in the part ID field is “bad”. The time field stores the time required to check the check items stored in the check item field. In the time field, for example, it takes more time to check the check items that take time, such as checking a vehicle at a maintenance shop, than check items that do not take time, such as checking by the user 10 himself. Information is stored in such a way that it becomes longer.

Specifically, the control unit 301 identifies a state field in which “bad” is stored in the state field of the vehicle information about the user 10 held in the vehicle information DB 304. The control unit 301 obtains the part ID corresponding to the status field in which “bad” is stored in the status field. Next, the control unit 301 checks the part ID corresponding to the part ID field held in the vehicle information DB 304 and the part ID corresponding to the state field in which “bad” is stored in the state field. Get item. That is, the control unit 301 obtains check items corresponding to parts in “bad” condition by referring to the correspondence information.

The control unit 301 determines the acquired check items as items that the user 10 should check in the vehicle 100 by the travel start date and time. In this way, control unit 301 determines the checklist depending on the state of vehicle 100. The control unit 301 generates checklist information including a checklist of items that the user 10 should check in the vehicle 100 by the travel start date and time. Then, the control unit 301 transmits the checklist information to the user terminal 200 at the transmission date and time using the communication unit 302.

In this embodiment, the control unit 301 obtains check items corresponding to parts in “bad” condition by referring to the correspondence information. On the other hand, the control unit 301 may acquire check items depending on the length of the movement distance (a predetermined distance or more). Specifically, the control unit 301 acquires a check item corresponding to a part in a “bad” state when the length of the moving distance is greater than or equal to a predetermined distance and less than a first threshold value. Further, the control unit 301 may acquire check items corresponding to parts in “bad” condition and parts in “normal” condition when the length of the movement distance is greater than or equal to the first threshold and less than the second threshold. good. Further, the control unit 301 may acquire all the check items when the length of the movement distance is equal to or greater than the second threshold. By acquiring check items according to the length of the travel distance in this way, it is possible to decide to check more check items as a checklist when the travel distance is longer.

Here, the control unit 301 refers to the correspondence information and sets the transmission date and time to a timing before the movement start date and time. The transmission date and time is a time set as a time when the user 10 who was prompted to check the vehicle 100 by the checklist information has time to check the vehicle 100. Specifically, the control unit 301 refers to the correspondence information held in the correspondence information DB 305 and determines the time required to check one or more check items included in the checklist (hereinafter sometimes referred to as “specific time”). Here, if the checklist includes a plurality of check items, the control unit 301 calculates the sum of the times required to check each check item as the specific time. Then, the control unit 301 sets the timing at which the movement start date and time arrives after a specific time and a predetermined time as the transmission date and time. Here, the predetermined time is set as a time when the checklist information is transmitted to the user terminal 200 at the transmission date and time, so that the vehicle 100 can be checked with plenty of time. By setting the transmission date and time in this way, the user terminal 200 transmits the checklist information at the transmission date and time set so that the vehicle 100 can be checked with plenty of time while taking into account the specific time. can be received. Information Processing

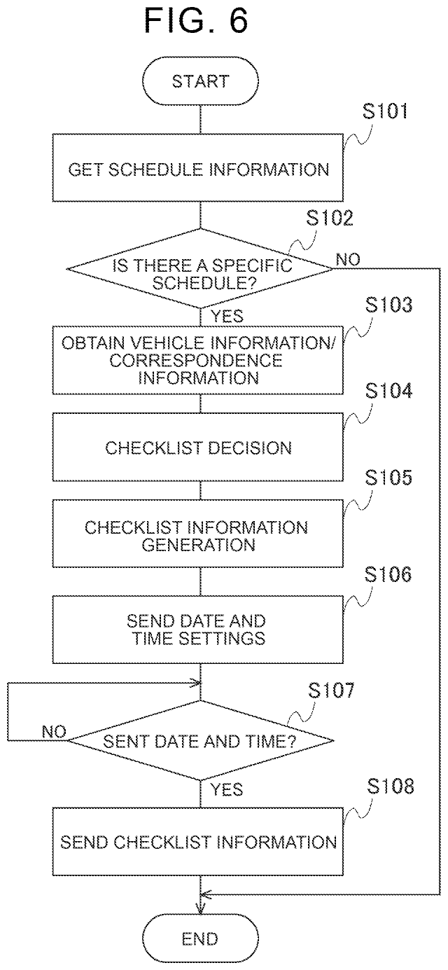

Next, information processing executed by the control unit 301 in the management server 300 in the notification system 1 will be described based on FIG. 6. FIG. 6 is a flowchart of information processing executed by the control unit 301. This process is repeatedly executed at predetermined intervals.

In the information processing shown in FIG. 6, first in S101, schedule information is acquired from the schedule information DB 303. Next, in S102, the schedule information is referred to and it is determined whether a specific schedule exists. If a negative determination is made in S102, there is no specific schedule in which the travel distance is greater than or equal to the predetermined distance. In this case, compared to the case where the vehicle 100 moves over a predetermined distance, it is assumed that there is a lower possibility that trouble will occur in the moving vehicle 100 even if the user 10 does not check the vehicle 100. Therefore, the information processing shown in FIG. 6 is temporarily ended.

If an affirmative determination is made in S102, vehicle information is acquired from the vehicle information DB 304 in S103. Here, the management server 300 receives vehicle information of the vehicle 100 in real time. Therefore, the vehicle information about the vehicle 100 held in the vehicle information DB 304 is information indicating the current state of the vehicle. Therefore, the control unit 301 can grasp the state of the vehicle 100 based on information indicating the latest state of the vehicle 100.

Further, in S103, correspondence information is acquired from the correspondence information DB 305. Next, in S104, the vehicle information and correspondence information are referred to and a checklist is determined. Next, in S105, checklist information is generated.

Next, in S106, the transmission date and time is set by referring to the correspondence information. Next, in S107, it is determined whether the transmission date and time has arrived. If a negative determination is made in S107, it is not the date and time to transmit the checklist information, so the process in S107 is executed again. If an affirmative determination is made in S107, the current time is the date and time when the checklist information is transmitted. Therefore, checklist information is transmitted to the user terminal 200 in S108. Then, the process shown in FIG. 6 is temporarily ended.

As explained above, the notification system 1 transmits checklist information to the user terminal 200 when the user 10 moves a predetermined distance or more. This prompts the user 10 to check the vehicle according to the checklist before the travel start date and time arrives. Further, the transmission date and time is set so that the user 10 who is prompted to check the vehicle 100 by the checklist information can have time to check the vehicle 100. Thereby, the user 10 can check the vehicle 100 with plenty of time. As a result, it is possible to suppress trouble occurring in the moving vehicle 100 due to vehicle maintenance and the like.

### First Modification

In the present embodiment, the management server 300 transmits checklist information to the user terminal 200 when the travel distance of the vehicle 100 is equal to or greater than a predetermined distance. However, a configuration may also be adopted in which the management server 300 transmits the checklist to the user terminal 200 when the travel time of the vehicle 100 is equal to or greater than a predetermined threshold. Even in such a case, it is possible to suppress trouble occurring in the vehicle 100 while the vehicle 100 is moving for a time longer than a predetermined threshold.

### Second Modification

In the present embodiment, the management server 300 determines the checklist by referring to vehicle information about the vehicle 100. However, the management server 300 may determine the checklist based on other than vehicle information.

For example, when the vehicle 100 moves under conditions where the temperature is high, it is assumed that troubles with the coolant will occur more likely than when the vehicle 100 moves under conditions where the temperature is low. Furthermore, for example, when the vehicle 100 moves under strong wind conditions, the washer fluid is often used to wipe away dust and the like attached to the windshield, compared to when the vehicle 100 moves under conditions without strong winds. is assumed. Therefore, when vehicle 100 moves under strong wind conditions, it is assumed that the possibility of washer fluid-related trouble occurring is higher than when moving under non-strong wind conditions.

Therefore, the management server 300 obtains, for example, weather information regarding the predicted weather while the vehicle 100 is traveling along the scheduled route. For example, the management server 300 acquires weather information from an external server that distributes weather information. Then, the management server 300 refers to the weather information and correspondence information held in the correspondence information DB 305 and determines a checklist. In this modification, the correspondence information held in the correspondence information DB 305 is information about the correspondence between each weather and the items to be checked when moving in each weather. Even in this case, it is possible to suppress trouble occurring in the moving vehicle 100.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of non-transitory computer-readable storage media include discs of any type such as magnetic disks (such as floppy disks or hard disk drives (HDD)), optical disks (such as Compact Disc Read Only Memory (CD-ROM), Digital Versatile Discs (DVD), or Blu-ray discs), read-only memory (ROM), random access memory (RAM), Erasable Programmable Read-Only Memory (EPROM), Electrically Erasable Programmable Read-Only Memory (EEPROM), magnetic cards, flash memory, or an optical card, any type of medium suitable for storing electronic instructions.

What is claimed is:

1. An information processing device comprising a control unit configured to:
acquire a travel start date and time when a vehicle is scheduled to start traveling and an expected route of the vehicle;
determine a checklist of items to be checked for the vehicle by a user of the vehicle by the travel start date and time when a travel distance or a travel time for travel of the vehicle on the expected route is greater than or equal to a threshold value; and
transmit checklist information including the checklist to a terminal associated with the user.

2. The information processing device according to claim 1, wherein:
the control unit is configured to further acquire information that indicates a state of the vehicle acquired by a sensor mounted on the vehicle; and
the determining of the checklist includes determining the checklist according to the state of the vehicle indicated by the acquired information.

3. The information processing device according to claim 1, wherein:
the control unit is configured to further acquire weather information about predicted weather while the vehicle is traveling on the expected route; and
the determining of the checklist includes determining the checklist according to the acquired weather information.

4. The information processing device according to claim 1, wherein:
the control unit is further configured to
acquire a specific time that is required to check one or more of the items included in the checklist, and
set a timing when the travel start date and time arrives after lapse of the specific time and a predetermined time as a transmission date and time to transmit the checklist information; and
the transmitting of the checklist information to the terminal includes transmitting the checklist information to the terminal at a timing when the set transmission date and time arrives.

5. An information processing method to be executed by a computer, the information processing method comprising:
acquiring a travel start date and time when a vehicle is scheduled to start traveling and an expected route of the vehicle;
determining a checklist of items to be checked for the vehicle by a user of the vehicle by the travel start date and time when a travel distance or a travel time for travel of the vehicle on the expected route is greater than or equal to a threshold value; and
transmitting checklist information including the checklist to a terminal associated with the user.
